(19) United States
(12) Patent Application Publication
(10) Pub. No.: US 2006/0156320 A1
(43) Pub. Date: Jul. 13, 2006

(54) Connection structure

(75) Inventor: Yung-Hua Lee, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/328,024

(22) Filed: Jan. 9, 2006

(30) Foreign Application Priority Data
Jan. 10, 2005 (TW) 094100671

(51) Int. Cl. G11B 33/02

(52) U.S. Cl. 720/647

(57) ABSTRACT

A connection structure is used for connecting a cover to a casing of equipment, so that the cover can be movably and rotatably opened. The casing has an opening covered by the cover. The connection structure includes a guiding member, a pivot, a resilient member, and a plate member. The guiding member, connected to the cover, has a guiding groove. The pivot is connected to the opening and is located into the guiding groove of the guiding member. The resilient member is connected to the opening and the plate member, respectively. The plate member abuts against the guiding member. When the cover is pushed inward relative to the casing, the resilient member is actuated, so that the resilient member pushes the plate member and the guiding member to move the cover and further to rotate, via the pivot, the cover outward relative to the casing.

### BACKGROUND OF THE INVENTION

1. Field of the Invention

The present invention relates to a connection structure, and more particularly to a connection structure applied in equipment for conveniently opening a cover of the equipment.

2. Description of the Prior Art

The conventional electronic equipment, such as a TV, a digital video disc (DVD) player, and so on, always disposes several functional buttons or sockets on the housing for the user to operate. In general, the conventional electronic equipment also mounts a rotatable cover for covering the buttons or sockets. When the user wants to operate the buttons or sockets of the conventional equipment, he/she only needs to rotate the cover outward relative to the equipment.

Referring to FIGS. 1A through 1C, FIG. 1A is an outside view illustrating a DVD player 10 of the prior art. FIG. 1B is an outside view illustrating a cover 14 rotating outward relative to the DVD player 10 shown in FIG. 1A. FIG. 1C is a side view illustrating a cover 14 rotating outward relative to the DVD player 10 shown in FIG. 1B. As shown in FIG. 1A, the conventional DVD player 10 comprises a housing 12, a plurality of pedestals 16, and a cover 14. When a user wants to operate the buttons or sockets of the player 10, he/she only needs to rotate the cover 14 outward relative to the player 10. However, because the cover 14 can only be opened by the way of rotation, the design of the DVD player 10 will be limited. As shown in FIG. 1A, two crevices must be respectively formed at each side of the cover 14 of the DVD player, so the cover 14 can be rotated outward relative to the housing 12. Furthermore, when the cover 14 is opened, the bottom of the cover 14 will protrude downward relative to the housing 12, so a specific height must be set under the front of the housing 12 of the DVD player 10. Accordingly, a plurality of pedestals 16 has to be added to raise the housing 12, and that will cause limitation in design, as shown in FIG. 1C. Moreover, the prior art always utilizes more complicated mechanism, e.g. hydraulic gear set, to control the rotation speed of the cover 14, so the cost will increase.

Therefore, the objective of the present invention is to provide a connection structure for movably and rotatably opening a cover of an equipment, so as to solve the above-mentioned problems.

### SUMMARY OF THE INVENTION

The objective of the present invention is to provide a connection structure for connecting a cover to a casing of equipment, so that the cover can be movably and rotatably opened. Accordingly, the design will be more variable, and the cost will decrease.

The present invention discloses a connection structure used for connecting a cover to a casing of equipment, so that the cover can be movably and rotatably opened. The casing of the equipment has an opening covered by the cover.

The connection structure comprises a guiding member, a pivot, a resilient member, and a plate member. The guiding member has a leading end, a connecting end, and a guiding groove, wherein the leading end has an outer arc edge and an inner arc edge, and the connecting end is connected to the cover. The pivot is connected to a first inner wall of the opening and located into the guiding groove of the guiding member. The resilient member has a first end and a second end, and the first end is connected to a second inner wall of the opening. The resilient member can be operated in a pre-compressure state or a releasing state. The plate member is pivotally mounted onto the second inner wall of the opening and connected to the second end of the resilient member. The plate member is disposed between the guiding member and the resilient member to abut against the outer arc edge of the leading end of the guiding member.

When the cover covers the opening, the leading end of the guiding member is relatively away from the pivot, the connecting end of the guiding member is relatively close to the pivot, and the resilient member is operated in the pre-compressure state. When the cover is pushed inward relative to the casing, the resilient member is actuated by the plate member and the guiding member and then operates from the pre-compressure state into the releasing state, so that the resilient member pushes the plate member and the guiding member to move the cover along the axial direction of the guiding groove and outward relative to the casing. Afterward, when the inner arc edge of the leading end of the guiding member contacts the pivot, because the resilient member keeps pushing the guiding member, the guiding member rotates outward relative to the casing via the inner arc edge of the leading end and the pivot, such that the cover, connected to the connecting end of the guiding member, rotates together with the guiding member outward relative to the casing.

According to the connection structure of the present invention, when a user wants to open the cover of the equipment, he/she only needs to push the cover inward relative to the casing of the equipment. When the cover is opened, the cover will move forward for a distance and then rotate outward. Therefore, the present invention not only avoids the crevices of the prior art formed at each side of the cover, but also does not need to keep a height under the bottom of the equipment. Accordingly, it will be more convenient for opening the cover, and the design will also be more variable.

The advantage and spirit of the invention may be understood by the following recitations together with the appended drawings.

### BRIEF DESCRIPTION OF THE APPENDED DRAWINGS

FIG. 1A is an outside view illustrating a DVD player of the prior art.

FIG. 1B is an outside view illustrating a cover rotating outward relative to the DVD player shown in FIG. 1A.

FIG. 1C is a side view illustrating a cover rotating outward relative to the DVD player shown in FIG. 1B.

FIG. 2 is a partial view illustrating a connection structure attached on a casing of equipment according to a preferred embodiment of the present invention.

FIG. 3A is a sectional view along line P-P illustrating the connection structure attached on the casing of equipment shown in FIG. 2.

FIG. 3B is a view illustrating the cover shown in FIG. 3A moving forward for a distance.

FIG. 3C is a view illustrating the cover shown in FIG. 3B rotating outward relative to the casing.

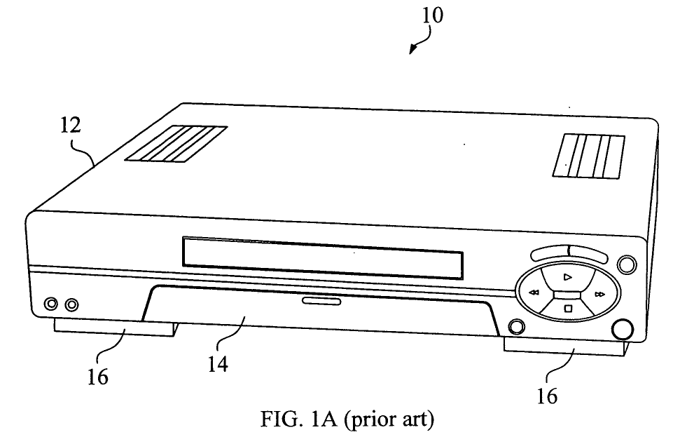

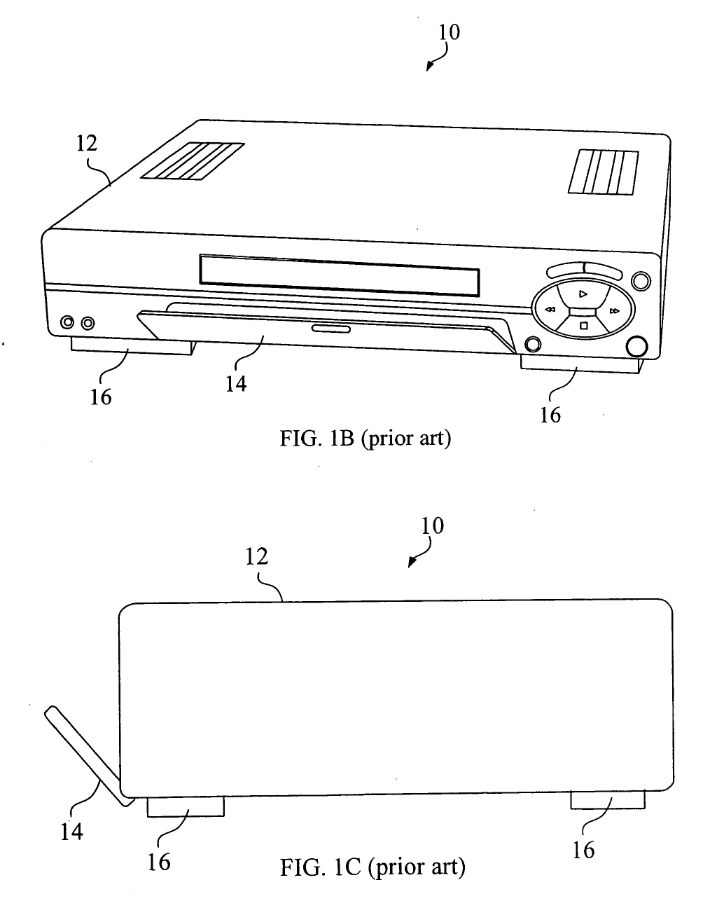

### DETAILED DESCRIPTION OF THE INVENTION

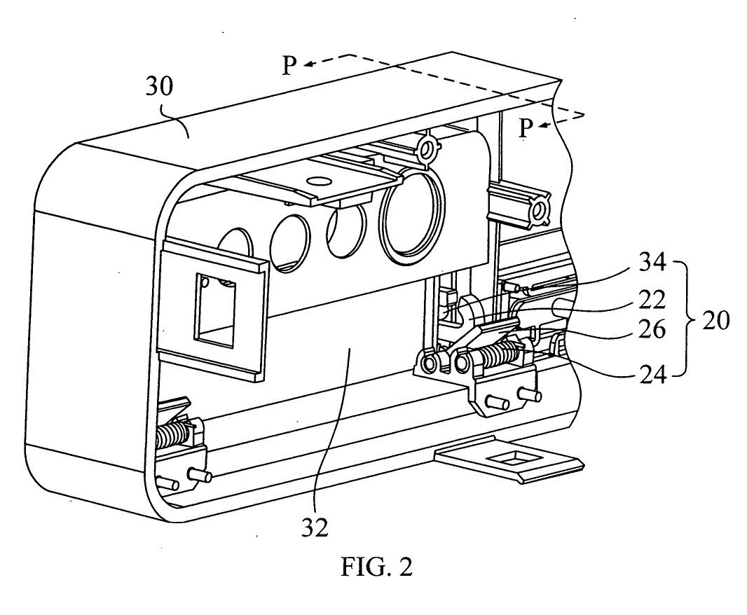

Referring to FIG. 2, FIG. 2 is a partial view illustrating a connection structure 20 attached on a casing 30 of equipment according to a preferred embodiment of the present invention. In this embodiment, the equipment (not shown in FIG. 2) can be a TV, a DVD player, and so on. The casing 30 has an opening and a cover 32 for covering the opening. The connection structure 20 comprises a guiding member 22, a pivot 34, a resilient member 24, and a plate member 26. The connection structure is used for connecting the cover 32 to the casing 30, so that the cover 32 can be movably and rotatably opened, as shown in FIG. 2.

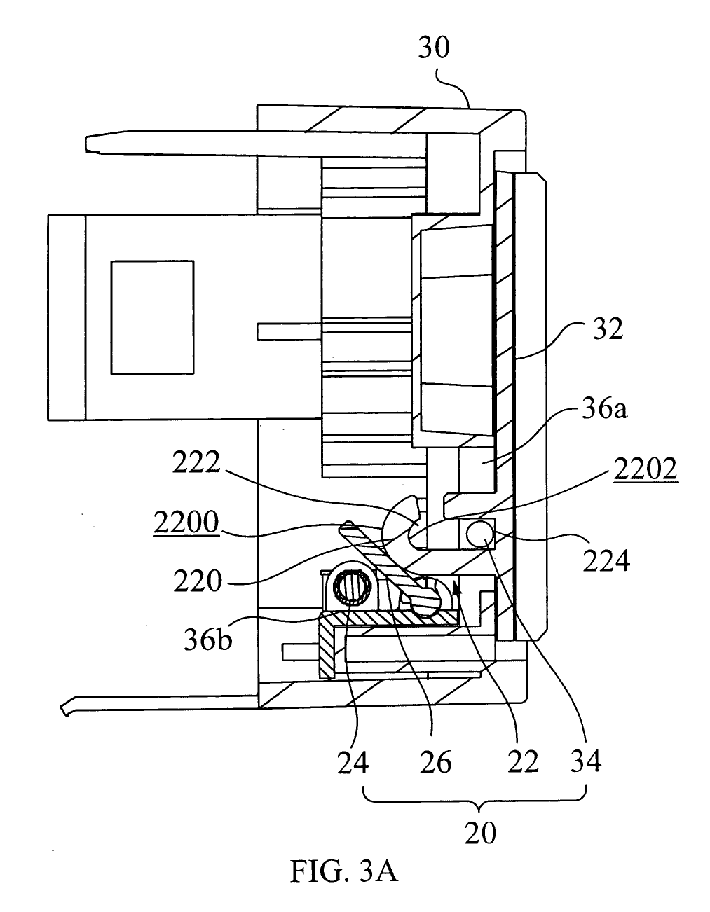

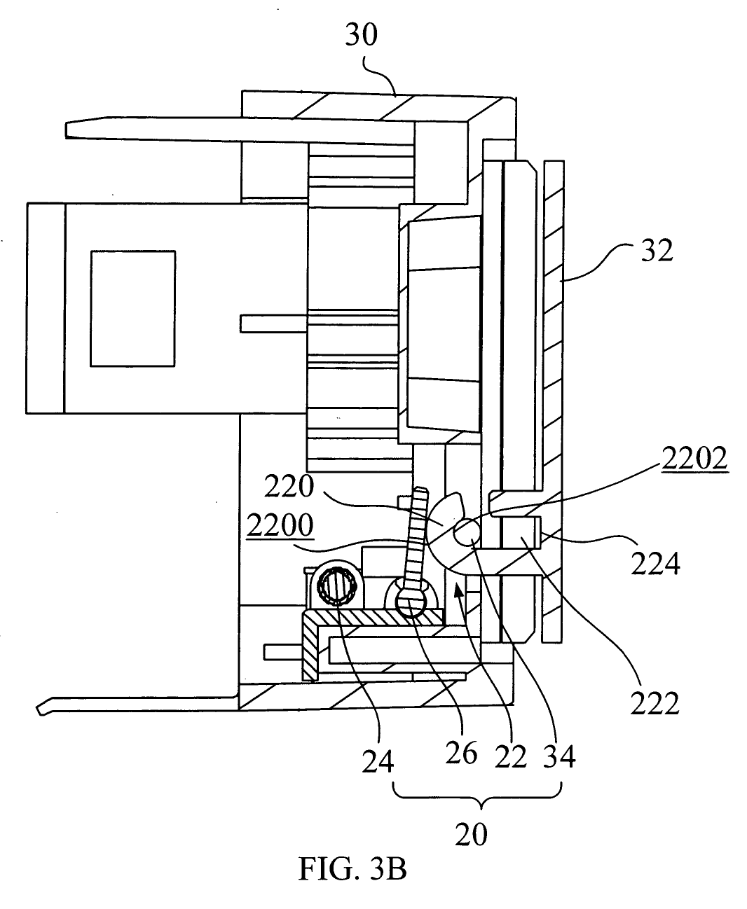

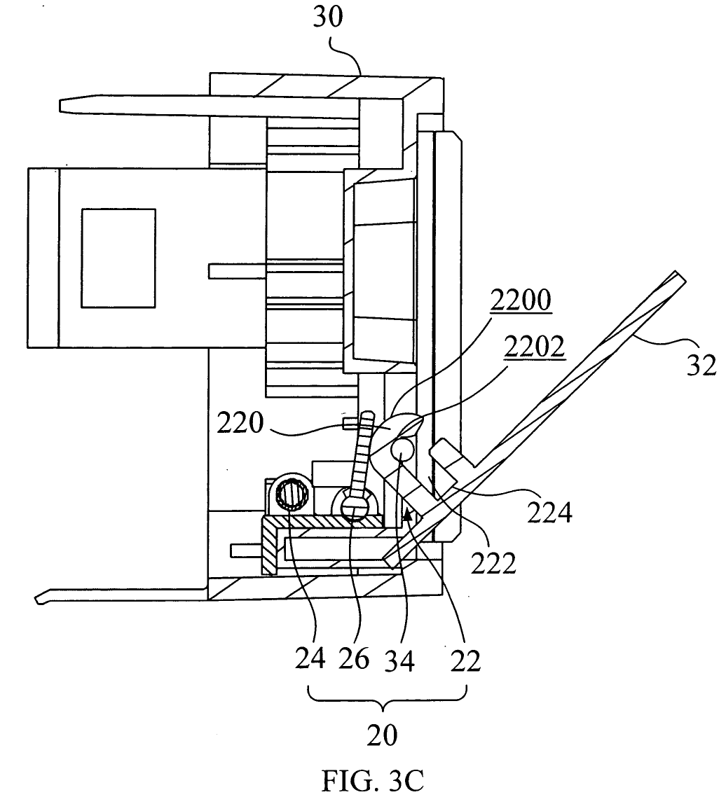

Referring to FIGS. 3A through 3C, FIG. 3A is a sectional view along line P-P illustrating the connection structure 20 attached on the casing 30 of equipment shown in FIG. 2. FIG. 3B is a view illustrating the cover 32 shown in FIG. 3A moving forward for a distance. FIG. 3C is a view illustrating the cover 32 shown in FIG. 3B rotating outward relative to the casing 30. As shown in FIG. 3A, the guiding member 22 has a leading end 220, a connecting end 224, and a guiding groove 222, wherein the leading end 220 has an outer arc edge 2200 and an inner arc edge 2202, and the connecting end 224 is connected to the cover 32. The pivot 34 is connected to a first inner wall 36a of the opening and located into the guiding groove 222 of the guiding member 22. The resilient member 24 has a first end and a second end (not shown), and the first end is connected to a second inner wall 36b of the opening. In this embodiment, the first inner wall 36a is perpendicular to the second inner wall 36b. The resilient member 24 can be operated in a pre-compressure state or a releasing state. The plate member 26 is pivotally mounted onto the second inner wall 36b of the opening of the casing 30 and connected to the second end of the resilient member 24. The plate member 26 is disposed between the guiding member 22 and the resilient member 24 to abut against the outer arc edge 2200 of the leading end 220 of the guiding member 22.

When the cover 32 covers the opening of the casing 30, the cover 32 engages with the casing 30, the leading end 220 of the guiding member 22 is relatively away from the pivot 34, the connecting end 224 of the guiding member 22 is relatively close to the pivot 34, and the resilient member 24 is operated in the pre-compressure state, as shown in FIG. 3A. When the cover 32 is pushed inward relative to the casing 30, the resilient member 24 is actuated by the plate member 26 and the guiding member 22 and then operates from the pre-compressure state into the releasing state, so that the resilient member 24 pushes the plate member 26 and the guiding member 22 to move the cover 32 along the axial direction of the guiding groove 222 and outward relative to the casing 30, as shown in FIG. 3B. In this embodiment, the axial direction of the guiding groove 222 is defined as the horizontal direction. Afterward, when the inner arc edge 2202 of the leading end 220 of the guiding member 22 contacts the pivot 34, because the resilient member 24 keeps pushing the guiding member 22, the guiding member 22 rotates outward relative to the casing 30 via the inner arc edge 2202 of the leading end 220 and the pivot 34, such that the cover 32, connected to the connecting end 224 of the guiding member 22, rotates together with the guiding member 22 outward relative to the casing 30, as shown in FIG. 3C. Accordingly, the cover 32 can be smoothly opened from the casing 30.

In this embodiment, the length of the guiding groove 222 of the guiding member 22 can be changed to control the distance which the cover 32 moves along the axial direction of the guiding groove 222. Furthermore, the resilient member 24 can be a torsion spring or the like. The present invention can control the rotation and movement speed of the cover 32 by adjusting the torsion of the resilient member 24 instead of installing more expensive device, so as to reduce the cost.

According to another preferred embodiment of the present invention, the first inner wall 36a and the second inner wall 36b can be the same inner wall of the opening of the casing 30. In other words, the pivot 34, the resilient member 24, and the plate member 26 can be mounted on the same inner wall of the opening of the casing 30. The function and principle of this embodiment are the same as the above-mentioned embodiment, and the duplicated description is not given again here.

Compared to the prior art, according to the connection structure of the present invention, when a user wants to open the cover of the equipment, he/she only needs to push the cover inward relative to the casing of the equipment. When the cover is opened, the cover will move forward for a distance and then rotate outward. Therefore, the present invention not only avoids the crevices of the prior art formed at each side of the cover, but also does not need to keep a height under the bottom of the equipment. Furthermore, the present invention can control the rotation speed of the cover by adjusting the torsion of the resilient member instead of installing more expensive device, so as to reduce the cost. Accordingly, it will be more convenient for opening the cover, and the design will also be more variable.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A connection structure in an equipment, the equipment comprising a casing having an opening and a cover for covering the opening, the connection structure for connecting the cover to the casing, comprising:
a guiding member having a leading end, a connecting end, and a guiding groove, the leading end having an outer arc edge and an inner arc edge, and the connecting end being connected to the cover;
a pivot connected to a first inner wall of the opening and located into the guiding groove of the guiding member;
a resilient member having a first end and a second end, the first end being connected to a second inner wall of the opening, the resilient member being operated in a pre-compressure state or a releasing state; and
a plate member pivotally mounted onto the second inner wall of the opening, connected to the second end of the resilient member, and disposed between the guiding member and the resilient member to abut against the outer arc edge of the leading end of the guiding member;
wherein when the cover covers the opening, the leading end of the guiding member is relatively away from the pivot, the connecting end of the guiding member is relatively close to the pivot, and the resilient member is operated in the pre-compressure state; and
when the cover is pushed inward relative to the casing, the resilient member is actuated by the plate member and the guiding member and then operates from the pre-compressure state into the releasing state, so that the resilient member pushes the plate member and the guiding member to move the cover along the guiding groove and outward relative to the casing, and when the inner arc edge of the leading end of the guiding member contacts the pivot, the guiding member rotates outward relative to the casing via the inner arc edge of the leading end and the pivot, such that the cover, connected to the connecting end of the guiding member, rotates together with the guiding member outward relative to the casing.

2. The connection structure of claim 1, wherein the first inner wall and the second inner wall are the same inner wall of the opening.

3. The connection structure of claim 1, wherein the first inner wall is perpendicular to the second inner wall.

4. The connection structure of claim 1, wherein the resilient member is a torsion spring.

5. An equipment, comprising:
a casing having an opening;
a cover for covering the opening; and
a connection structure for connecting the cover to the casing, comprising:
a guiding member having a leading end, a connecting end, and a guiding groove, the leading end having an outer arc edge and an inner arc edge, and the connecting end being connected to the cover;
a pivot connected to a first inner wall of the opening and located into the guiding groove of the guiding member;
a resilient member having a first end and a second end, the first end being connected to a second inner wall of the opening, the resilient member being operated in a pre-compressure state or a releasing state; and
a plate member pivotally mounted onto the second inner wall of the opening, connected to the second end of the resilient member, and disposed between the guiding member and the resilient member to abut
against the outer arc edge of the leading end of the guiding member;
wherein when the cover covers the opening, the leading end of the guiding member is relatively away from the pivot, the connecting end of the guiding member is relatively close to the pivot, and the resilient member is operated in the pre-compressure state; and
when the cover is pushed inward relative to the casing, the resilient member is actuated by the plate member and the guiding member and then operates from the pre-compressure state into the releasing state, so that the resilient member pushes the plate member and the guiding member to move the cover along the guiding groove and outward relative to the casing, and when the inner arc edge of the leading end of the guiding member contacts the pivot, the guiding member rotates outward relative to the casing via the inner arc edge of the leading end and the pivot, such that the cover, connected to the connecting end of the guiding member, rotates together with the guiding member outward relative to the casing.

6. The equipment of claim 5, wherein the first inner wall and the second inner wall are the same inner wall of the opening.

7. The equipment of claim 5, wherein the first inner wall is perpendicular to the second inner wall.

8. The equipment of claim 5, wherein the resilient member is a torsion spring.
